(19) United States
(12) Patent Application Publication
(10) Pub. No.: US 2025/0241223 A1
(43) Pub. Date: Jul. 31, 2025

(54) DISK DRIVE FOR AGRICULTURAL EQUIPMENT, AND AGRICULTURAL EQUIPMENT

(71) Applicant: Marchesan Implementos e Máquinas Agrícolas Tatu S.A., Matão SP (BR)

(72) Inventors: José Luiz Alberto Marchesan, Matão SP (BR); Carlos Cezar Galhardi, Matão SP (BR)

(21) Appl. No.: 19/042,156

(22) Filed: Jan. 31, 2025

(30) Foreign Application Priority Data
Jan. 31, 2024 (BR) 102024002077-4

(51) Int. Cl. A01B 71/04; A01B 21/08

(52) U.S. Cl. CPC A01B 71/04; A01B 21/086

(57) ABSTRACT

The present invention refers to a disk unit (200) for agricultural equipment (100) comprising a bracket (210, 220) configured to receive a profile of the agricultural equipment (100), the bracket (210) comprising an upper projection (211) and a lower projection (221); an arm (230) with an upper end (231), a lower end (232), and an upper projection (233) positioned near the upper end (231); a spring assembly (240) with a rod (241) that accommodates a spring (242), a guide (243), and a set of pressure nuts (244), the rod (241) having an upper end (241A) that is associated with the guide (243) and a lower end (241B); a disk (250) associated with the lower end (232) of the arm (230); wherein the upper projection (211) of the bracket (210, 220) is rotatably associated with the guide (243) of the spring assembly (240) and the lower projection (221) of the bracket (210, 220) is rotatably associated with the upper end (231) of the arm (230); and wherein the lower end (241B) of the rod (240) is rotatably associated with the upper projection (233) of the arm (230).

### CROSS REFERENCE TO RELATED APPLICATIONS

This application claims priority to and the benefit of Brazilian Application No. BR102024002077-4, filed Jan. 31, 2024; the contents of which as are hereby incorporated by reference in their entirety.

### BACKGROUND

### Technical Field

The present invention is related to a disk unit applicable to agricultural equipment, particularly in soil preparation equipment, which adjusts the working pressure of the individual disks according to different needs or field conditions encountered.

### Description of Related Art

Modern agricultural equipment used in soil preparation is equipped with individual disks (instead of the known sections of agricultural harrows) and has been preferred for performing high-speed tasks (“Speed Tillers”) for acting on crop residues in general. This preference for individual disks is due both to the fact that they have a large free span between them (providing a greater flow of straw/debris), and to the ability of each disk to oscillate individually to overcome any obstacles found on the ground. In this individual disk equipment, for operation at higher speeds, the use of damping elements (Elastomers) installed between the support of said disks and the structure of the equipment prevails, so that they absorb the impacts from working on the agricultural field. Some relevant examples of documents that disclose this type of individual disk are U.S. Pat. Nos. 9,398,738, 11,330,752, and WO2004004438. Documents with damping carried out by compression or traction springs are also found, for example: U.S. Pat. No. 9,398,737; WO0219792 and CZ2021529.

In arable soils, there are great variations in the texture and structure of these soils, in addition to the cultivation of different types of crops that provide different types of vegetation remaining on the soil after harvest. Thus, it is desirable to have agricultural equipment equipped with individual disks and with resources to adjust the cutting depth thereof, for its efficient performance in different soil textures (Sandy, Medium, Clay Soil), with an adequate adjustment range for the various working conditions of the equipment, which characteristics are not seen in the disk units of the state of the art.

### BRIEF SUMMARY

A first objective of the present invention is to provide a disk device for soil preparation that allows the variation (adjustment) of the working pressure of the individual disks in order to adapt the working depth (penetration) to the different soil textures, resistance to cutting, as well as to the different types of vegetation remaining on the soil.

This invention relates to a disk unit for agricultural equipment comprising a bracket configured to receive a profile of the agricultural equipment, the bracket comprising an upper projection and a lower projection; an arm with an upper end, a lower end, and an upper projection positioned near the upper end; a spring assembly with a rod that accommodates a spring, a guide, and a pressure nut set, the rod having an upper end that is associated with the guide and a lower end; a disk associated with the lower end of the arm; wherein the upper projection of the bracket is rotatably associated with the guide of the spring assembly and the lower projection of the bracket is rotatably associated with the upper end of the arm; and wherein the lower end of the rod is rotatably associated with the upper projection of the arm.

In an embodiment, the support is formed by a first upper part and a second lower part associated with each other.

In one embodiment, the upper and lower parts of the support each comprise a plate, the plates being arranged in opposition to each other and being associated with each other, the association between the pair of plates configuring an opening to receive the profile of the agricultural equipment.

In one embodiment the arm comprises a body of curved geometry.

In one embodiment, the association between the arm and the disk is made through a bearing.

In one embodiment, the pressure nut set is associated with the upper end of the rod via a pin assembly;

The present invention further includes an agricultural equipment that comprises a disk unit such as the one defined above in any of its embodiments.

### BRIEF DESCRIPTION OF THE FIGURES

The present invention will be described in more detail below based on an execution example represented in the drawings. The figures show:

FIG. 1—is a perspective view of an agricultural equipment comprising the disk unit of the present invention in a preferred embodiment;

FIG. 2A—is a first perspective view of the disk unit of the present invention in a preferred embodiment;

FIG. 2B—is a second perspective view of the disk unit of the present invention in a preferred embodiment;

FIG. 2C—is a side view of the disk unit of the present invention in a preferred embodiment;

FIG. 3—is an exploded perspective view of the disk unit of the present invention in a preferred embodiment;

FIG. 4—is a perspective view of the disk unit support of the present invention in a preferred embodiment;

FIG. 5—is a perspective view of the arm of the disk unit of the present invention in a preferred embodiment; and

FIG. 6—is a perspective view of the disk unit support of the present invention in a preferred embodiment.

### DETAILED DESCRIPTION OF VARIOUS EMBODIMENTS

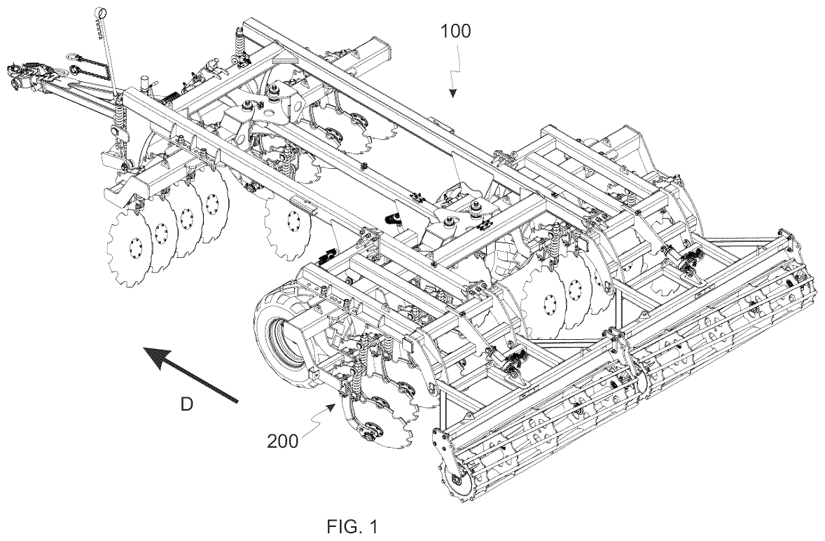

First, it should be noted that the term “preferable” used herein is intended to characterize an embodiment of particular efficiency of the invention among the multiple possible ones. The term “preferable” should not be understood as limiting the possible embodiments of this invention, that is, it should not be understood as “imperative” or “mandatory” for the execution of this invention. It is further clarified that the terms referring to the directions and orientations of certain elements of the invention (for example, “forward,” “down,” and other similar terms) discussed throughout this description should be considered in relation to the horizontal plane of the ground and the working direction of the agricultural equipment, the latter being notably represented in this embodiment by the arrow “D” in FIG. 1.

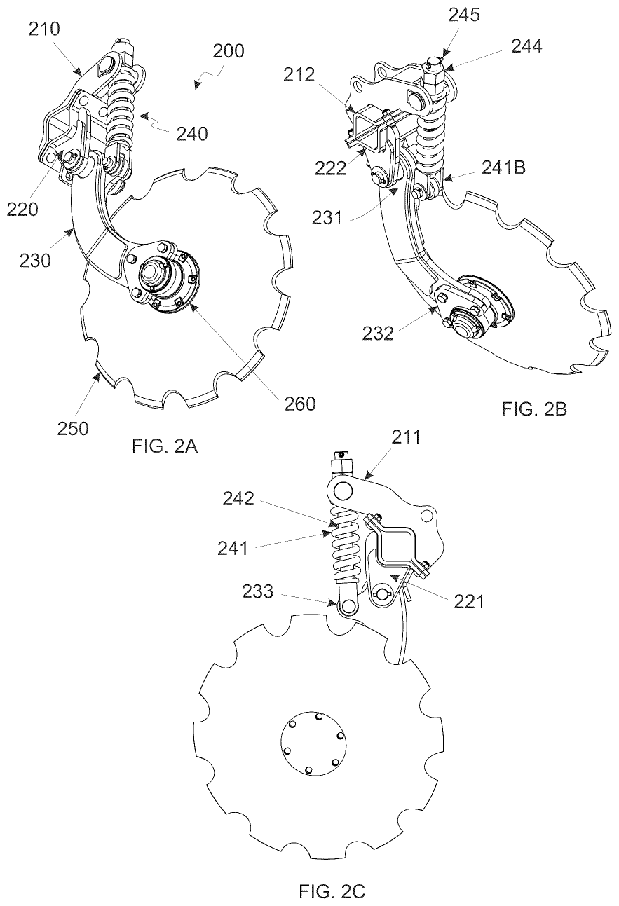

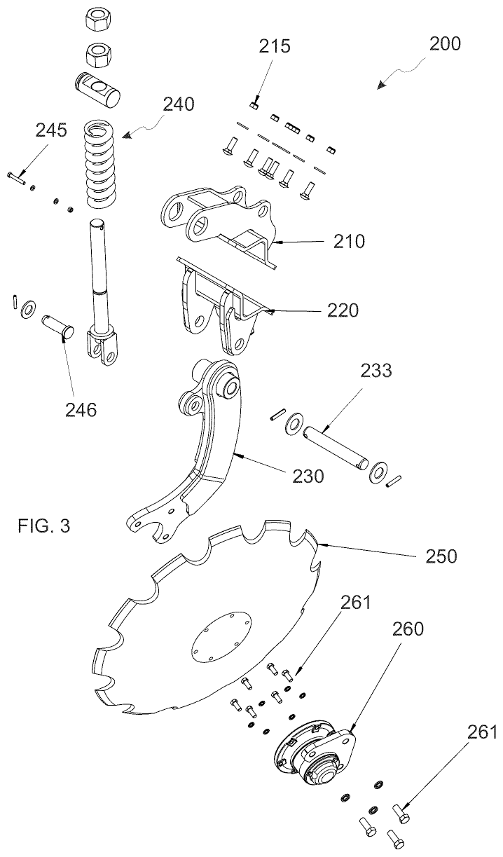

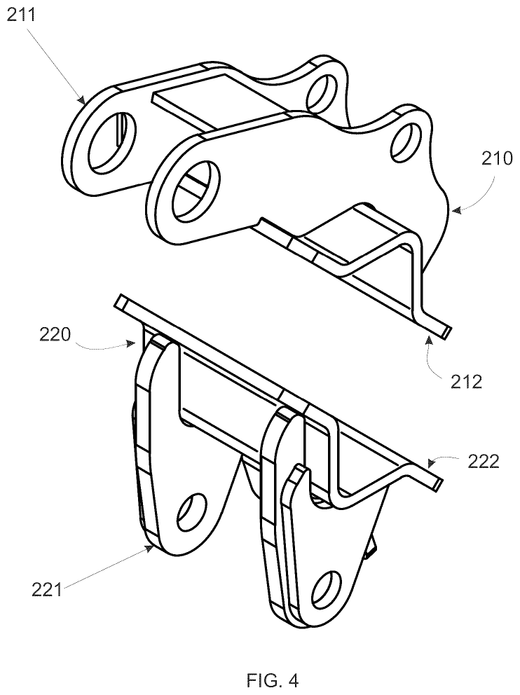

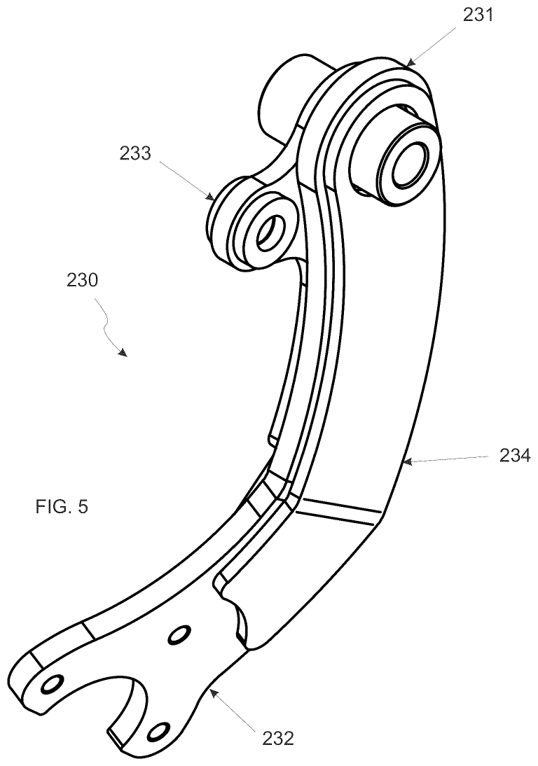

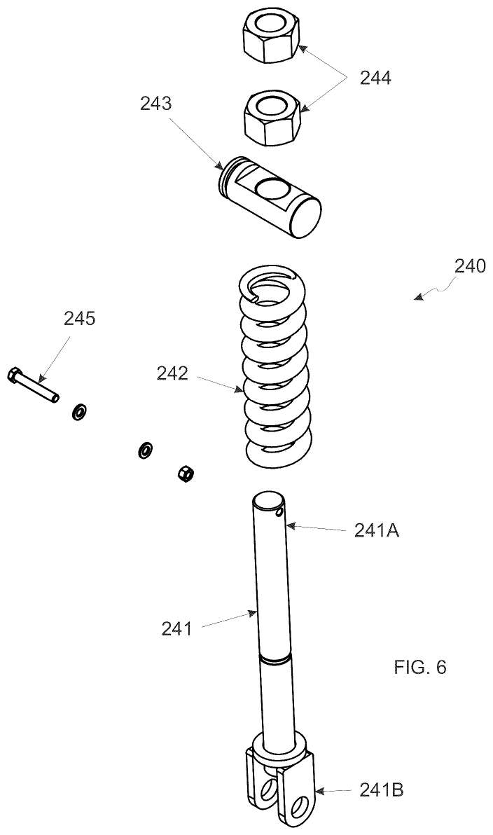

FIG. 1 discloses the disk unit 200 of the present invention applied to an agricultural soil preparation equipment 100. FIGS. 2A, 2B, and 2C disclose views of the mounted disk unit 200, while FIG. 3 discloses an exploded view of the disk unit 200.

The disk unit 200 comprises a bracket 210, 220 configured to receive a profile of the agricultural equipment 100, for example, a tool line profile. Said bracket 210, 220 comprises an upper projection 211 that preferably extends forward, and a lower projection 221 that preferably extends downwards. Preferably, the bracket 210, 220 is bipartite, formed by a first upper part 210 and a second lower part 220 associated with each other. More preferably, each upper 210 and lower 220 part of the bracket 210, 220 comprises a respective plate 212, 222 which is arranged in an internal region of its respective part 210, 220. Each upper part 210 and lower part 220 of the bracket 210, 220 can comprise a recess for receiving its respective plate 212, 222. Plates 212, 222 preferably comprise a “V” shape and are arranged in opposition to each other, which can be joined by sets of screws. The association between plates 212, 222 forms a hollow opening for receiving or passing the profile of agricultural equipment 100 in order to associate the disk unit 200 with the structure of said equipment 100.

The disk unit 200 comprises an arm 230 with an upper end 231 and a lower end 232. Preferably, the arm 230 comprises a body 234 in a curved shape, to allow an adequate course of a spring assembly 240 when compensating for irregularities in the ground, as we will see later. Arm 230 further comprises an upper projection 233 arranged near or adjacent to the upper end 231, extending backwards.

The disk unit 200 further comprises a spring assembly equipped with a rod 241, which is inserted into the interior of a spring 242. The rod 241 has a top end 241A which is associated with a guide 243 and a set of pressure nuts 244. The pressure nut set preferably comprises a pair of nuts associated in series and confined to the rod via a pin assembly 245.

The assembly of the disk unit 200 in this preferred embodiment will now be described. The top projection 211 of the bracket 210, 220 is rotatably associated with the guide 243 of the spring assembly 240. Preferably, the guide 243 has a cylindrical shape that coincides with a hole in the upper projection 211 of the bracket 210, 220 to facilitate the association. The lower projection 221 of the bracket 210, 220 is rotatably associated with the upper end 231 of the arm 230, preferably by means of a set of rod and pins 233. The lower end 241B of the rod 240 is rotatably associated with the upper projection 233 of the arm 230, preferably by means of a rod and pin assembly 246, and the lower portion 232 of the arm 230 is associated with the disk 250 through the bearing 260 and bolt assemblies 261.

As to the operation of the disk unit 200, adjusting the tightness of the set of pressure nuts 244 forces the guide 243 over the spring 240 and allows the adjustment of the pressure exerted on the arm 230, which consequently adjusts the pressure exerted by the disk 250 on the ground. It will be understood that the constructive arrangement of the disk unit 200 also allows for a stress-dampening effect (impact absorption) experienced by the disk 250.

Having described a preferred embodiment, it should be understood that the scope of the present invention encompasses other possible variations, being limited only by the content of the appended claims, including possible equivalents.

1. Disk unit (200) for agricultural equipment (100), the disk unit (200) comprising:
a bracket (210, 220) configured to receive a profile of agricultural equipment (100), the bracket (210) comprising an upper projection (211) and a lower projection (221);
an arm (230) provided with an upper end (231), a lower end (232), and an upper projection (233) arranged near the upper end (231);
a spring assembly (240) equipped with a rod (241) that receives a spring (242), a guide (243), and a set of pressure nuts (244), the rod (241) being provided with an upper end (241A) that connects to the guide (243) and a lower end (241B); and
a disk (250) associated with the lower end (232) of the arm (230);
wherein:
the upper projection (211) of the bracket (210, 220) is rotatably associated with the guide (243) of the spring assembly (240) and the lower projection (221) of the bracket (210, 220) is rotatably associated with the upper end (231) of the arm (230); and
the lower end (241B) of the rod (240) is rotatably associated with the upper projection (233) of the arm (230).

2. Disk unit (200) for agricultural equipment (100), according to claim 1, wherein the bracket (210, 220) is formed by a first upper part (210) and a second lower part (220) associated with each other.

3. Disk unit (200) for agricultural equipment (100), according to claim 2, wherein that that the upper and lower parts of the bracket (210, 220) each comprise a plate (212, 222), the plates (212, 222) being arranged in opposition to each other and being associable with each other, the association between the pair of plates (212, 222) forming an opening to receive the profile of the agricultural equipment (100).

4. Disk unit (200) for agricultural equipment (100), according to claim 1, wherein the arm (230) comprises a body (234) of curved geometry.

5. Disk unit (200) for agricultural equipment (100), according to claim 1, wherein the association between the arm (230) and the disk (250) is made through a bearing (260).

6. Disk unit (200) for agricultural equipment (100), according to claim 1, wherein the set of pressure nuts (244) is associated with the upper end (241A) of the rod (241) through a pin assembly (245);

7. Agricultural equipment (100), comprising a disk unit (200) as defined in claim 1.
